(19) United States
(12) Patent Application Publication
(10) Pub. No.: US 2002/0057952 A1
(43) Pub. Date: May 16, 2002

(54) High-speed milling machine

(75) Inventor: Wolfgang Haferkorn, Frankfurt (DE)

Correspondence Address: THE FIRM OF KARL F ROSS, 5676 RIVERDALE AVENUE, PO BOX 900, RIVERDALE (BRONX), NY, 10471-0900, US

(73) Assignee: WALDRICH SIEGEN WERKZEUGMASCHINEN GMBH

(21) Appl. No.: 10/035,484

(22) Filed: Nov. 7, 2001

(30) Foreign Application Priority Data
Nov. 8, 2000 (DE) 20019035.0

(51) Int. Cl. B23C 1/12

(52) U.S. Cl. 409/201; 409/211; 409/216

(57) ABSTRACT

A machining apparatus has a guide extending in an x-direction, an x-slide displaceable in the x-direction on the guide, a y-slide displaceable in a y-direction generally perpendicular to the x-direction on the x-slide, and a z-slide displaceable in a z-direction generally perpendicular to the x- and y-directions on the y-slide. A tool holder is pivotal about a holder axis generally parallel to the x-direction on the z-slide and carries a tool rotatable about a tool axis perpendicular to the holder axis on the z-slide. The tool holder and tool have a center of mass generally at the holder axis. An actuator tips the tool holder and tool relative to the z-slide about the holder axis on the z-slide.

### FIELD OF THE INVENTION

The present invention relates to a high-speed milling machine. More particularly this invention concerns such a machine where the rotating milling tool is moved in mutually perpendicular x, y, and z directions.

### BACKGROUND OF THE INVENTION

In a standard three-dimensional milling system a guide extending in an x-direction carries an x-slide displaceable in the x-direction on the guide. A y-slide is displaceable in a y-direction generally perpendicular to the x-direction on the x-slide, and a z-slide is displaceable in a z-direction generally perpendicular to the x- and y-directions on the y-slide. A tool holder fixed to the z-slide carries a tool and rotatable about a tool axis normally parallel to the z-direction. Thus while the workpiece is held stationary the tool is moved in the x-, y-, and z-directions over it to machine into it a three-dimensional shape, normally according to a program in a controller connected to x-, y-, and z-actuators braced on the respective slides.

During such machining of a three-dimensional shape into a workpiece, the inertia of the accelerating masses of the various slides, which can be considerable, is a problem. Instantaneous high accelerations can lead to vibration of the machine parts, creating chatter and a spoiled workpiece. When in fact the y-slide is accelerated rapidly, there is deformation in the displacement direction so that, when the acceleration stops, the slide not only returns to its undeformed position, but often moves briefly past it, creating a bad cut.

It has been suggested to take such deformations into account and program the actuators accordingly. This is, however, very complex and rarely yields the desired accurate cut, so the only practical solution is to move the slides very slowly to prevent such deformation-causing accelerations and decelerations from putting the milling tool where it should not be.

### OBJECTS OF THE INVENTION

It is therefore an object of the present invention to provide an improved three-dimensional milling apparatus.

Another object is the provision of such an improved three-dimensional milling apparatus which overcomes the above-given disadvantages, that is which moves the tool with high accuracy even at relatively fast slide-travel speeds.

### SUMMARY OF THE INVENTION

A machining apparatus has according to the invention a guide extending in an x-direction, an x-slide displaceable in the x-direction on the guide, a y-slide displaceable in a y-direction generally perpendicular to the x-direction on the x-slide, and a z-slide displaceable in a z-direction generally perpendicular to the x- and y-directions on the y-slide. In accordance with the invention a tool holder is pivotal about a holder axis generally parallel to the x-direction on the z-slide and carries a tool rotatable about a tool axis perpendicular to the holder axis on the z-slide. The tool holder and tool have a center of mass generally at the holder axis. An actuator tips the tool holder and tool relative to the z-slide about the holder axis on the z-slide.

In this manner the parts of the machining apparatus that have a relatively large mass such as the x- and y-slides, are moved with a relatively small acceleration of for example 1 to 2 m/s² while the relatively low-mass parts here formed by the tool and support can be accelerated at a greater rate. Since the pivot axis of the low-mass support and tool assembly extends perpendicular to the x-direction, pivoting of this assembly about its axis in effect displaces the tool in the x-direction, adding to it a component of movement that will not deform the x- or y-slide. With such a system accelerations exceeding 1 g can be used on a regular basis since the mass of the parts being accelerated is relatively small.

According to the invention the support is a fork. In addition counterweights are carried on the y-slide for counterbalancing the z-slide, holder, and tool. The counterweight is displaceable on the y-slide in the z-direction and the counterweight is coupled mechanically to the z-slide. More particularly there are two of the counterweights flanking the z-slide and respective wheels are engaged between the counterweights and respective sides of the z-slide. The wheels are pinions and the sides and counterweights have racks meshing with the pinions. To further prevent vibration caused by harmonic movement, a pneumatic damper is braced against the z-slide for impeding movement of same in the z-direction.

### BRIEF DESCRIPTION OF THE DRAWING

The above and other objects, features, and advantages will become more readily apparent from the following description, reference being made to the accompanying drawing in which:

FIG. 1 is a schematic perspective view of the milling apparatus according to the invention;

FIG. 2 is a larger-scale side view of a detail of FIG. 1;

FIG. 3 is a partly schematic view illustrating details of the apparatus; and

FIG. 4 is a diagrammatic view showing how the system according to the invention functions.

### SPECIFIC DESCRIPTION

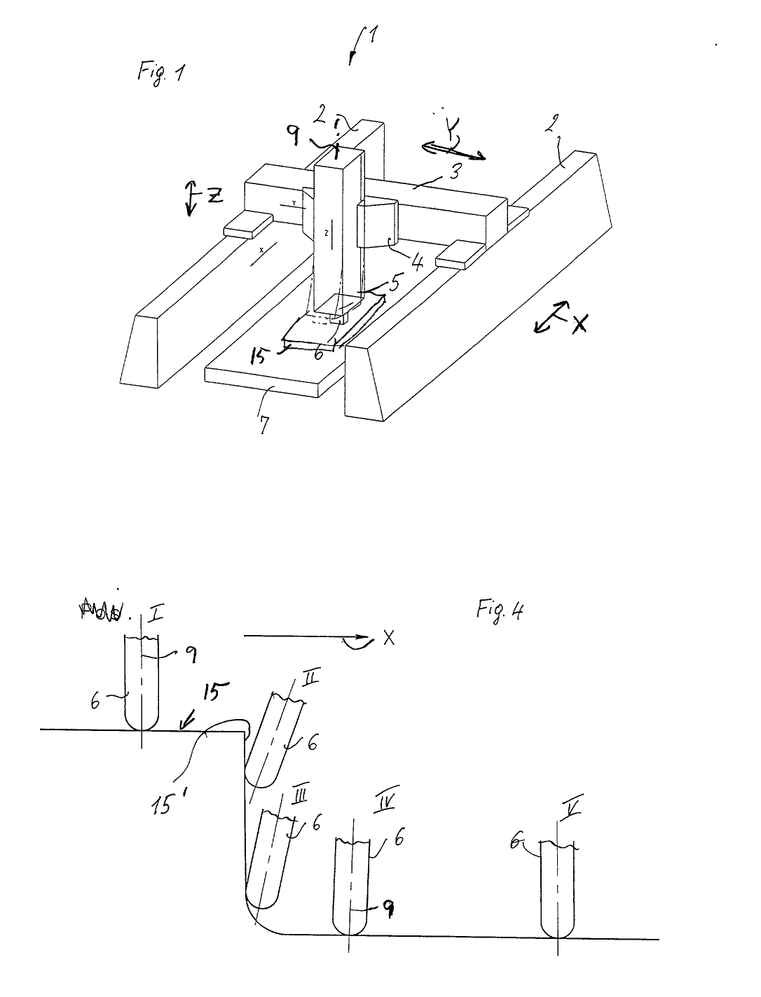

As seen in FIG. 1 a milling apparatus 1 has a substantially stationary guide 2 on which a first traverse or x-slide 3 can move in a horizontal x-direction. A second slide 4 can move on the traverse 3 in a horizontal y-direction extending at 90° to the x-direction. A third slide 5 can move on the second y-slide 4 in a vertical z-direction perpendicular to the x- and y-directions. The z-slide 5 carries as shown in FIG. 2 a holder 8 in turn fitted with a milling tool 6 engageable with a workpiece 15 clamped to a table 7. The tool 6 is rotated about a vertical axis 9 extending in the z-direction. Thus as the tool 6 is rotated and moved across the workpiece 15 while in contact with it, the tool 6 mills this workpiece 15.

According to the invention as shown in FIG. 2 the tool 6 can be rocked as shown by arrow 12 by a schematically illustrated actuator 10 about a horizontal axis 11 extending through the axis 9 parallel to the y-direction. The pivotal parts, here the holder 8 and tool 6, have a center of mass 14 that lies on this axis 11 so that it is stable in virtually any position.

FIG. 2 shows operation of this system as the tool 6 passes through five different positions I through V as it moves across a workpiece 15 and over a step 15′ in the workpiece surface. In position 1 the x-slide 3 is moving in the x-direction but when it reaches the step 15′ the actuator 10 tips the tool 6 as shown in positions II and III. When returning to a surface parallel to the x-direction the tool 6 is again upright as shown at IV and V. Of course during all this movement the tool 6 is rotating about its axis 9 which extends perpendicular to the x-direction.

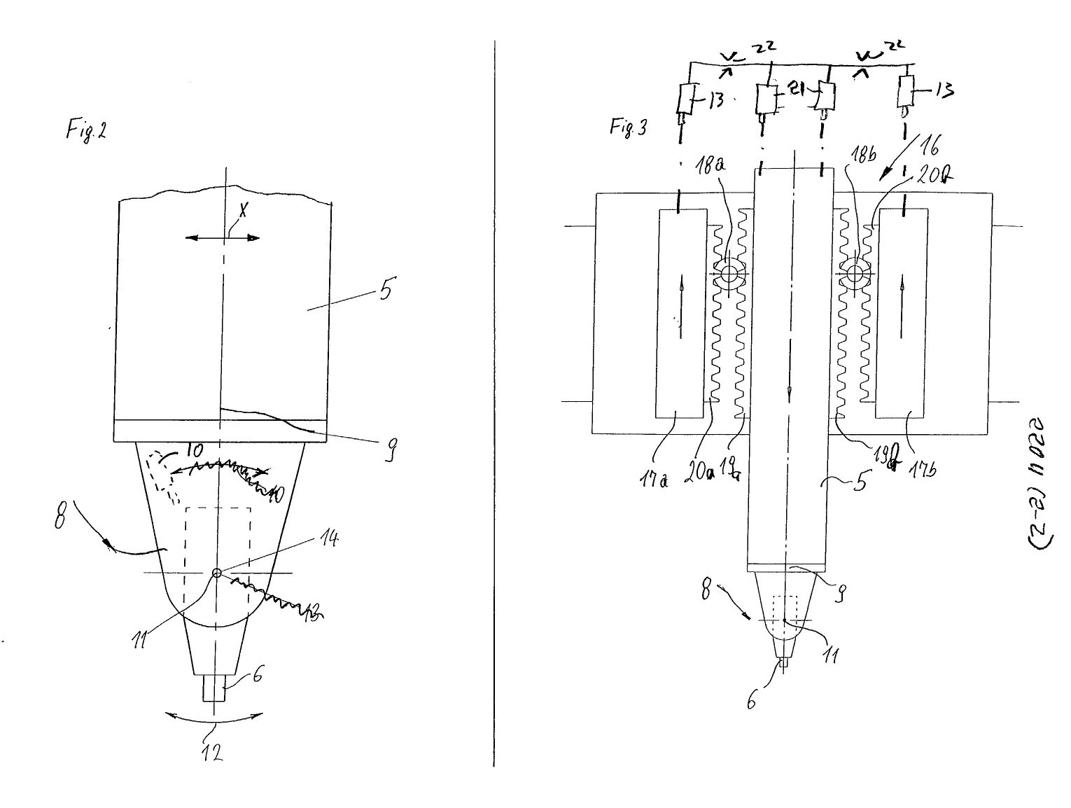

In order to cancel out the weight of the z-slide 5 and the support 8 and tool 6 carried by it, a counterweight system 16 as shown in FIG. 3 is used. A pair of vertically slidable counterweights 17a and 17b flank the z-slide 5 and confront identically toothed racks 19a and 19b on the respective sides of the z-slide 5. Respective pinions 18a and 18b meshing with the respective racks 17a, 17b, 19a, and 19b move the weights 17a and 17b, which have the same mass as the z-slide 5 plus the parts carried on it, up when the z-slide 5 moves down, and vice versa. Furthermore respective pairs of interconnected cylinders 13 and 21 are connected to the parts 17a, 17b, and 5 so as to damp vertical movement, preventing sudden changes in position. To this end the front compartments of the cylinders 13 connected to the weights 17a and 17b are connected to the back compartments of the respective cylinders 21 connected to the z-slide 5, and the cylinders 13 and 21 are of the same effective piston surface area for complementary movement in a closed pneumatic system. Variable restrictions 22 between the cylinders 13 and the respective cylinders 21 control the damping effect.

I claim:

1. A machining apparatus comprising:
a guide extending in an x-direction;
an x-slide displaceable in the x-direction on the guide;
a y-slide displaceable in a y-direction generally perpendicular to the x-direction on the x-slide;
a z-slide displaceable in a z-direction generally perpendicular to the x- and y-directions on the y-slide;
a tool holder pivotal about a holder axis generally parallel to the x-direction on the z-slide;
a tool carried in the holder and rotatable about a tool axis perpendicular to the holder axis on the z-slide, the tool holder and tool having a center of mass generally at the holder axis; and
an actuator for tipping the tool holder and tool relative to the z-slide about the holder axis on the z-slide.

2. The machining apparatus defined in claim 1 wherein the support is a fork.

3. The machining apparatus defined in claim 1 further comprising
means including counterweights carried on the y-slide for counterbalancing the z-slide, holder, and tool.

4. The machining apparatus defined in claim 3 wherein the means wherein the counterweight is displaceable on the y-slide in the z-direction and the means further comprises
means coupling the counterweight to the z-slide.

5. The machining apparatus defined in claim 4 wherein there are two of the counterweights flanking the z-slide, the coupling means including respective wheels engaged between the counterweights and respective sides of the z-slide.

6. The machining apparatus defined in claim 5 wherein the wheels are pinions and the sides and counterweights have racks meshing with the pinions.

7. The machining apparatus defined in claim 3, further comprising
pneumatic damping means braced against the z-slide for impeding movement of same in the z-direction.
